(19) United States
(12) Patent Application Publication
(10) Pub. No.: US 2005/0240914 A1
(43) Pub. Date: Oct. 27, 2005

(54) Portable just-in-time compilation in managed runtime environments

(75) Inventors: Todd A. Anderson, Beaverton, OR (US); Robert C. Knauerhase, Portland, OR (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/828,191

(22) Filed: Apr. 21, 2004

(51) Int. Cl. G06F 9/45

(52) U.S. Cl. 717/148

(57) ABSTRACT

The portability of a just-in-time compiler may be increased by enabling it to inquire as to the need, during the just-in-time compilation, for special byte code from a managed runtime environment in which it may be employed. This may be useful, for example, to permit a just-in-time compiler to be compatible with different managed runtime environments that implement various operations in various ways. Such operations may include garbage collection, storage of values for static fields, threading, or exception handling.

### BACKGROUND OF THE INVENTION

With the development of portable languages, such as Java, just-in-time compilers (JITs) have been developed as a means to increase the speed of portable code execution in managed runtime environments (MRTEs) in which programs written in such portable languages may be executed. In general, different MRTEs may operate differently from one another. Consequently, different MRTEs may require JITs that have been specially designed and/or customized for those different MRTEs.

### BRIEF DESCRIPTION OF THE DRAWINGS

Various embodiments of the invention will now be described in connection with the associated drawings, in which:

FIG. 1 depicts a conceptual block diagram showing data flow according to an exemplary embodiment of the invention;

FIG. 2 depicts a flowchart according to an exemplary embodiment of the invention; and

FIG. 3 depicts a conceptual block diagram of a system that may be used to implement an exemplary embodiment of the invention.

### DETAILED DESCRIPTION OF EMBODIMENTS OF THE INVENTION

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

According to some embodiments of the invention, an algorithm may be considered to be a self-consistent sequence of acts or operations leading to a desired result. These may include physical manipulations of physical quantities. Usually, though not necessarily, these quantities may take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities, as applicable, and are merely convenient labels applied to these quantities.

According to some embodiments discussed below, terms such as “processing,” “computing,” “calculating,” “determining,” or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, in some embodiments, the term “processor” may refer to any device or portion of a device that processes electronic data from registers and/or memory to transform that electronic data into other electronic data that may be stored in registers and/or memory. A “computing platform” may, in some embodiments, comprise one or more processors.

Some embodiments of the present invention may include apparatuses for performing the operations herein. An apparatus may be specially constructed for the desired purposes, or it may comprise a general purpose device selectively activated or reconfigured by a program stored in the device.

Some embodiments of the invention may be implemented in one or a combination of hardware, firmware, and software. Embodiments of the invention may also be implemented as instructions stored on a machine-accessible medium, which may be read and executed by a computing platform to perform the operations described herein. A machine-accessible medium may include any mechanism for storing or transmitting information in a form readable by a machine (e.g., a computer). For example, a machine-accessible medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

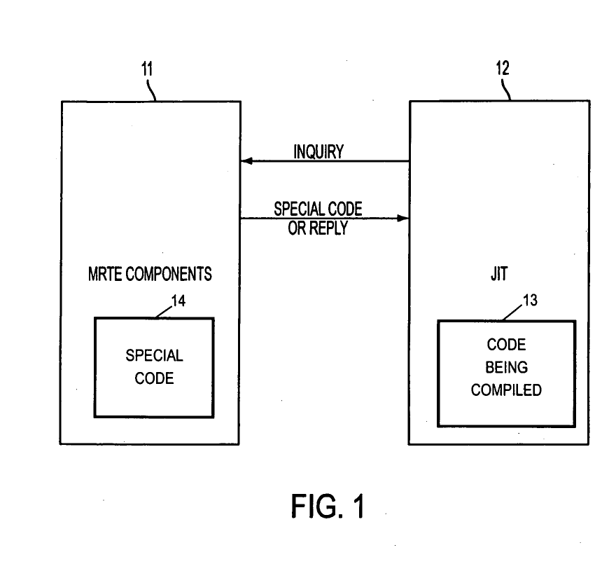

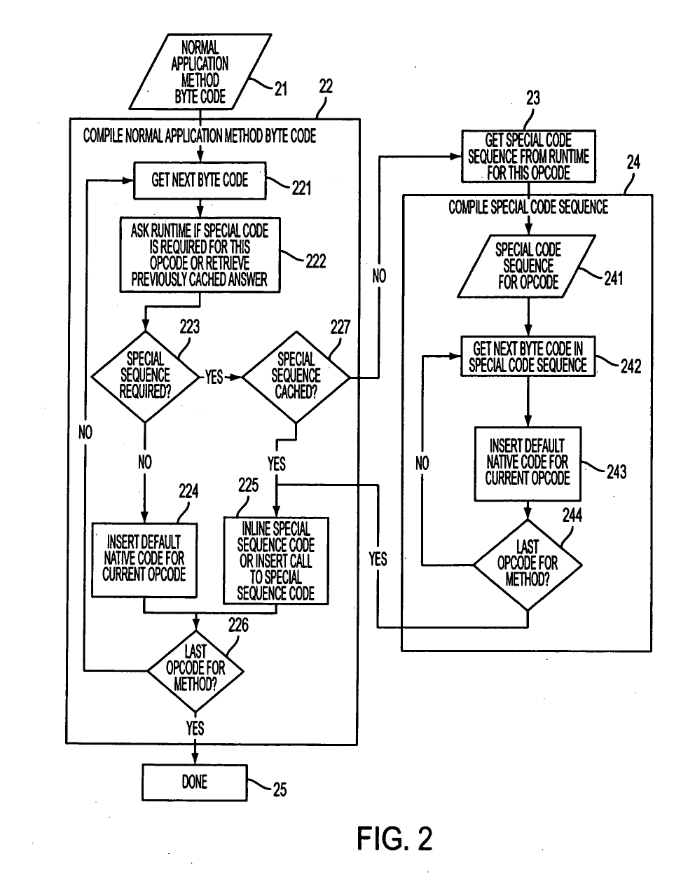

FIG. 1 depicts a conceptual block diagram showing data flow between a JIT and other components of a MRTE according to an exemplary embodiment of the invention. As shown, the other MRTE components 11 and JIT 12 may communicate information regarding code 13 being compiled by the JIT 12. According to some embodiments of the invention, a simplified concept is that JIT 12, when reaching a code element (e.g., a byte code of a language being compiled) for which an MRTE may need the use of special code (which may comprise one or more byte codes), may send an inquiry to the MRTE 11 (i.e., to at least one other component of the MRTE). In response, MRTE may reply in the negative (i.e., that no special code is needed or available) or may send such special code 14 to the JIT 12 for compilation. The process, for some embodiments of the invention, may be clarified by considering the flowchart of FIG. 2.

FIG. 2 depicts a flowchart outlining how a JIT may operate according to some embodiments of the invention. At block 21, the JIT may receive a method that may comprise byte code. Block 22, exclusive of blocks 222, 223, 225, and 227 (and the associated connections with blocks 23 and 24), may represent the operation of a JIT that does not interact with the rest of a local MRTE during the compilation process for the purpose of inquiring about special code sequences (the JIT may interact with other components of the MRTE for other purposes). As discussed above, such a JIT may need to be customized to automatically account for special needs of the MRTE. In contrast, a JIT according to some embodiments of the invention may interact with other components of an MRTE during compilation, as discussed in connection with FIG. 1, to permit the JIT to receive MRTE-specific information.

In particular, within block 22, the JIT may take the method byte code obtained in block 21 and may consider the next individual byte code (note that, in the context of an individual instruction, the terms “byte code” and “opcode” are used interchangeably in FIG. 2 and in its associated discussion here) in block 221. The JIT, according to some embodiments of the invention, may then inquire of the MRTE (i.e., other components of the MRTE), at block 222, if any special code (or, more generally, “special code sequence”) may be required for this particular byte code. In some embodiments, the JIT may be programmed to know for which byte codes special code may be needed, and may only make inquiries when such byte codes are encountered. As will be discussed in further detail below, in connection with block 227, the inquiry of block 222 may include a case, in some embodiments, in which special code has previously been required and corresponding special sequence code (i.e., results of processing the special code) stored for a particular byte code.

If, in block 223, it is found that no special sequence (code) is required, the process may continue with block 224 and may insert default native code (i.e., native to the MRTE) for the byte code under consideration. If the byte code under consideration was the last one for the method, block 226, the process may be complete, block 25. Otherwise, the process may loop back to block 221 and may consider a next byte code for compilation.

If, in block 223, it is found that a special sequence (code) is required, a corresponding special sequence may then be obtained. In some embodiments, a JIT may store previously-received and previously-processed special code from the MRTE in a cache or other memory (to be referred to, but not limited to, a “cache” in the remainder of this discussion). That is, once a particular byte code has been considered in such embodiments, there may be no need to once again obtain a special sequence of byte code (“special code sequence”) for that byte code and to process it into a special sequence of native code (“special sequence code”); rather, the special sequence code may be retrieved without making a further inquiry of the MRTE. Therefore, in such embodiments, the process may continue with block 227 and may determine if the required special sequence code has already been stored (or, in accordance with the above comment, “cached”). If the required special sequence code was previously cached, then the process may continue to block 225 and may inline the special sequence code or insert a call to the special sequence code; this will be discussed further below. If the special sequence code was not previously cached, or if the embodiment lacks a caching capability, the process may proceed with block 23 and may obtain the special code sequence from the MRTE. The JIT may then proceed to block 24 and may process the special code sequence, labeled as block 241 within block 24, to obtain the associated native code (i.e., the special sequence code). In a first step, the JIT may consider a next byte code 242 within the special code sequence 241, obtained from the MRTE in block 23. The JIT may then operate to insert native (MRTE) code for the byte code under consideration, as noted in block 243. If there is another byte code to consider, block 244, the process may loop back to block 242. Otherwise, the process may return to block 22, and more specifically, may return to block 225.

Block 225 represents that a JIT, according to some embodiments of the invention, may make a decision as to how to treat the native code (i.e., the “special sequence code”) obtained from the special code sequence (i.e., in block 24) or previously cached (i.e., as discussed in connection with block 227). There may be two options: to inline the special sequence code within the overall method being compiled by the JIT; or to insert into the overall method a call to the special sequence code obtained from the special code sequence. In general, this decision may be based on one or more optimization criteria that may be based on known heuristic methods.

Following block 225, the process may proceed to block 226 and may further proceed as described above.

There may be numerous circumstances in which a component of an MRTE 11 may wish to have the JIT 12 implement a certain byte code in a particular way. For example, different garbage collection (GC) algorithms may require special types of support from a JIT. One type of GC algorithm, a reference counting GC, may require the that the JIT insert code to increment an object's reference count when another reference is made to point to the object and to decrement the object's reference count when an object reference is made to point away from the object (and to delete the object, or tag the object for deletion, when its reference count is zero). Another type of GC algorithm, a generational GC algorithm, may require that the JIT insert a special code sequence that may perform work when a pointer in an elder generation is modified to point into a younger generation. Still other types of GC algorithms may require that the JIT insert special code for various types of reads and writes to pointers and/or to memory. Therefore, the above-described method may enable a JIT to accommodate various types of GC algorithms that may be used in different MRTEs.

In another example, a particular type of virtual machine (VM), which may be a type of JIT, may not use a particular type of function or sequence of operations, for example, to store a value for a static field. However a particular runtime environment with which one may wish to use the VM may use such a function or sequence of operations. In such a case, for the VM, which corresponds to the JIT in this case, to accommodate the runtime environment, it may need to obtain the proper function or sequence of operations to be able to be compatible with the runtime environment. The process described above, if implemented as part of the VM (and accommodated by the runtime environment), may permit the VM to accommodate the runtime environment's requirements.

Further examples of byte codes that may require special treatment in a particular MRTE may include byte codes used for threading and/or byte codes used for exception handling.

A problem that may possibly arise is if a special code sequence obtained from the MRTE for a particular byte code were to be recursive (i.e., if it were to include the particular byte code for which the special code sequence was being provided). This may occur either directly, where the special code sequence calls itself (i.e., the byte code for which it is being inserted), or indirectly, where the byte code for a first special code sequence requires a second special code sequence that contains a byte code for the first special code sequence. In general, such a chain of byte codes and special sequences may be of arbitrary length, which may make it difficult to detect such recursiveness. However, an MRTE may be engineered such that no special code sequence may be required for a byte code within a special code sequence. Consequently, one approach to this problem, according to one exemplary embodiment of the invention, may be for a JIT to keep track of whether it is currently compiling a normal code sequence or a special code sequence, and if the JIT is compiling a special code sequence, then it may include a default implementation of byte codes forming the special code sequence, where such a default implementation would ensure non-recursiveness.

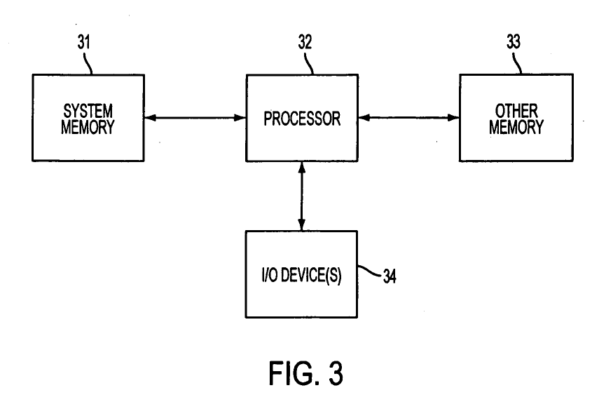

Some embodiments of the invention, as discussed above, may be embodied in the form of software instructions on a machine-accessible medium. Such an embodiment may be illustrated in FIG. 3. The computer system of FIG. 3 may include at least one processor 32, with associated system memory 31, which may store, for example, operating system software and the like. The system may further include additional memory 33, which may, for example, include software instructions to perform various applications. System memory 31 and additional memory 33 may comprise separate memory devices, a single shared memory device, or a combination of separate and shared memory devices. The system may also include one or more input/output (I/O) devices 34, for example (but not limited to), keyboard, mouse, trackball, printer, display, network connection, etc. The present invention may be embodied as software instructions that may be stored in system memory 31 or in additional memory 33. Such software instructions may also be stored in removable or remote media (for example, but not limited to, compact disks, floppy disks, etc.), which may be read through an I/O device 34 (for example, but not limited to, a floppy disk drive). Furthermore, the software instructions may also be transmitted to the computer system via an I/O device 34, for example, a network connection; in such a case, a signal containing the software instructions may be considered to be a machine-accessible medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. A method of just-in-time compilation, comprising:
inquiring if a byte code requires special code in a managed runtime environment;
compiling said byte code to execute in said managed runtime environment if said byte code does not require special code; and
performing the following if special code is required:
obtaining special code; and
compiling said special code to execute in said managed runtime environment.

2. The method according to claim 1, wherein said inquiring comprises:
sending an inquiry to said managed runtime environment.

3. The method according to claim 1, wherein said obtaining comprises:
receiving said special code from said managed runtime environment.

4. The method according to claim 1, wherein said obtaining comprises:
reading said special code from a memory.

5. The method according to claim 1, wherein said performing further comprises:
storing said special code in a memory.

6. The method according to claim 1, wherein each said compiling comprises:
translating byte code into native code by inserting a default set of native instructions corresponding to each byte code.

7. The method according to claim 1, wherein said compiling in said performing comprises one of a group consisting of:
compiling said special code inline; and
compiling said special code as a native method.

8. The method according to claim 1, wherein said special code for said byte code comprises special code selected from a group consisting of:
special code to implement said byte code for use in garbage collection;
special code to implement said byte code for use in storing a value for a static field;
special code to implement said byte code for use in threading; and
special code to implement said byte code for use in exception handling.

9. A machine-accessible medium that provides instructions, which when executed by a computing platform, cause said computing platform to perform operations comprising:
inquiring if a byte code requires special code in a managed runtime environment;
compiling said byte code to execute in said managed runtime environment if said byte code does not require special code; and
performing the following if special code is required:
obtaining special code; and
compiling said special code to execute in said managed runtime environment.

10. The machine-accessible medium according to claim 9, wherein said inquiring comprises:
sending an inquiry to said managed runtime environment.

11. The machine-accessible medium according to claim 9, wherein said obtaining comprises:
receiving said special code from said managed runtime environment.

12. The machine-accessible medium according to claim 9, wherein said obtaining comprises:
reading said special code from a memory.

13. The machine-accessible medium according to claim 9, wherein said performing further comprises:
storing said special code in a memory.

14. The machine-accessible medium according to claim 9, wherein each said compiling comprises:
translating byte code into native code by inserting a default set of native instructions corresponding to each byte code.

15. The machine-accessible medium according to claim 9, wherein said compiling in said performing comprises one of a group consisting of:
compiling said special code inline; and
compiling said special code as a native method.

16. The machine-accessible medium according to claim 9, wherein said special code for said byte code comprises special code selected from a group consisting of:
special code to implement said byte code for use in garbage collection;
special code to implement said byte code for use in storing a value for a static field;
special code to implement said byte code for use in threading; and
special code to implement said byte code for use in exception handling.

17. A system, comprising:
at least one processor adapted to support a managed runtime environment; and
at least one memory coupled to said at least one processor;
said system being adapted to perform a method comprising:
inquiring if a byte code requires special code in a managed runtime environment;
compiling said byte code to execute in said managed runtime environment if said byte code does not require special code; and
performing the following if special code is required:
obtaining special code; and
compiling said special code to execute in said managed runtime environment.

18. The system according to claim 17, wherein said obtaining comprises:
reading said special code from at least one said memory.

19. The system according to claim 17, wherein said performing further comprises:
storing said special code in at least one said memory.

20. The system according to claim 17, wherein said obtaining comprises:
receiving said special code from said managed runtime environment.

21. The system according to claim 17, wherein said special code for said byte code comprises special code selected from a group consisting of:
special code to implement said byte code for use in garbage collection;
special code to implement said byte code for use in storing a value for a static field;
special code to implement said byte code for use in threading; and
special code to implement said byte code for use in exception handling.
